(19) United States
(12) Patent Application Publication
(10) Pub. No.: US 2008/0191424 A1
(43) Pub. Date: Aug. 14, 2008

(54) Rotary seal

(75) Inventors: Dirk Gebauer, Berlin (DE); Rainer Jung, Berlin (DE); Sebastian Kahler, Berlin (DE)

Correspondence Address: KAPLAN GILMAN GIBSON & DERNIER L.L.P., 900 ROUTE 9 NORTH, WOODBRIDGE, NJ, 07095, US

(73) Assignee: Bandelin electronic GmbH & Co., KG, Berlin (DE)

(21) Appl. No.: 11/937,037

(22) Filed: Nov. 8, 2007

Related U.S. Application Data
(60) Provisional application No. 60/865,064, filed on Nov. 9, 2006.

(51) Int. Cl. F16J 15/32; B32B 1/08

(52) U.S. Cl. 277/402; 428/34.1

(57) ABSTRACT

The invention relates to a rotary seal, a vessel and also to use of the vessel. According to the invention, the rotary seal contains a sealing element and a retaining means, the sealing element being configured as a planar structure with an opening which can be changed in its opening cross-section and the retaining means having a first retaining part and a second retaining part (5) which can be rotated relative to each other, and first retaining part and second retaining part respectively being connected securely to the sealing element at least at one attachment point , the attachment points being chosen such that the sealing element can be deformed by rotation of the first and second retaining part such that the opening of the sealing element is reduced in its opening cross-section.

### CROSS REFERENCE TO RELATED APPLICATIONS

This application claims the benefit of U.S. Provisional Patent Application No: 60/865,064, filed Nov. 9, 2006, the entire disclosure of which is hereby incorporated by reference.

### TECHNICAL FIELD

The invention relates to a rotary seal, a vessel having a rotary seal according to the invention as a cover, and also to use of the vessel.

### BACKGROUND

It is known, in the field of minimally invasive surgery (MIS), to use tubular shaft instruments or hollow instruments. In order to clean tubular shaft instruments after use, it is known to pump a liquid through the tubular shaft or cavity, see for example the publication DE 44 41 401 A1.

In order to ensure that the liquid is pumped through the tubular shafts which generally have a very small diameter, it is necessary to seal the end at which the pumping is intended to take place relative to the end at which liquid is intended to be suctioned into the tubular shaft, in an adequate manner relative to each other.

Furthermore, the hollow shaft instruments can have different outer diameters. It is therefore advantageous if a seal takes into account these different outer diameters.

The publication DE 82 11 691 U1 discloses a sealing sleeve made of elastic material for wall leadthroughs, the sleeve having a conical configuration and being provided with opening cross-sections of different sizes. By means of these, objects can be sealed, the outer diameters of which are in the intermediate range of the diameters of both opening cross-sections of the sealing sleeve. However, it is a disadvantage that the sealing effect of the sealing sleeve is dependent upon the outer diameter of the object to be led through, in particular good sealing of objects with outer diameters in the range of the smaller of the two opening cross-sections of the sealing sleeve can be inadequate, and sealing of objects with an outer diameter smaller than the smaller of the two opening cross-sections of the sealing sleeve is absolutely impossible.

The publication DE 103 33 365 A1 likewise discloses a seal with a variable inner diameter. The seal has at least one annular sealing disc made of an at least flexible and/or elastic material with an opening which is adapted to the cross-sectional form of the object to be led through, the sealing disc having an undulating profile in the circumferential direction of the opening and the opening of the sealing disc having an inner end face which can be applied on the outer peripheral face of the element to be led through and which forms a continuous sealing face on the outer peripheral face of the element to be led through. The opening cross-section in this case can be effected by stretching or stiffening the undulating profile of the sealing disc. It is a disadvantage that a change in the opening cross-section whilst maintaining an adequate sealing effect is possible only over a limited range.

### SUMMARY OF THE INVENTION

It is therefore an object of the invention to produce a seal with an opening which is variable in its opening cross-section, which enables a change in the opening cross-section within a very wide range and is able, at the same time, to ensure a high sealing effect, is easy to use and also can be produced economically. A further object of the invention is to produce a vessel which has a seal of this type and also to propose an advantageous use of a vessel of this type.

The invention produces a rotary seal, containing a sealing element and a retaining means, the sealing element being configured as a planar structure with an opening which can be changed in its opening cross-section and the retaining means having a first retaining part and a second retaining part which can be rotated relative to each other, and first retaining part and second retaining part respectively being connected securely to the sealing element at least at one attachment point, the attachment points being chosen such that the sealing element can be deformed by rotation of the first and second retaining part such that the opening of the sealing element is reduced in its opening cross-section.

The retaining parts can be configured to be rotatable relative to each other for example manually, by motor, pneumatically or hydraulically.

For the sake of simplicity, only “attachment points” are subsequently mentioned, which however if not expressly stated otherwise, are also only intended to include a single attachment point for the first and/or second retaining part.

According to the invention, the sealing element attached to the retaining parts is compressed more and more by rotation of the retaining parts, as a result of which the opening cross-section of the opening of the sealing element is reduced. If an object is located in the opening, for example a tubular shaft instrument, then the sealing element abuts initially, during rotation of the retaining parts, against the outer surface of the shaft and, during further rotation of the retaining parts, is pressed more and more strongly against this outer surface. In this way, not only the initially open intermediate space between shaft and sealing element can be closed but also a high sealing effect can be achieved.

As a result of the fact that the sealing element is compressed during rotation of the retaining parts, the opening cross-section of the opening of the sealing element can be varied over a large range, in particular it is possible with a suitable configuration of the sealing element to close the opening of the sealing element completely.

As a result of the fact that rotation of the retaining parts is required in order to reduce or to close the opening of the sealing element, the rotary seal can be used in a particularly simple manner.

Preferably, the sealing element is elastically deformable, hence comprises in regions, preferably completely, an elastic material.

By using an elastic material, it can be ensured not only that the sealing element is sufficiently deformable in order to be able to reduce the opening cross-section over a large range, if not able to close the opening even completely, but can also ensure that the sealing element returns to its original shape when rotating back the retaining parts. This is sensible in particular if the seal is intended to be used many times and the opening of the sealing element is intended to have the same shape in the non-deformed state.

The material or materials of the sealing element have special physical parameters in order to be able to ensure high mechanical loading during rotation over a wide diameter range with high endurance (use approx. 500 times without failure). Advantageously, it is resistant relative to chemical disinfectants, contains no plasticisers and cannot be damaged by ultrasound.

Advantageously, the elastic region of the sealing element has in this respect a breaking elongation of at least 300%, preferably at least 600%, particularly preferred at least 800%. Preferably, the Shore A hardness is in the range of 20-40. Resistance to tear propagation is preferably in the range of 10-30 N/mm.

Preferably, the sealing element comprises at least in regions, particularly preferred completely, silicon rubber, in particular addition-cross-linked silicon rubber types, thermoplastic elastomers, in particular “Mediprene”, latex (natural rubber) and/or polymer latex.

Preferably, the sealing element comprises a material or materials which can be injection moulded.

Preferably the surface of the sealing element is continuous.

A rotary seal according to the invention can be used in particular for sealing against fluids, amongst which there should be understood in addition to gaseous and liquid media, in particular also pasty media.

An advantageous development of the invention provides that at least the first and/or second retaining part is or are attached to the sealing element, without interruption, along a continuous line which surrounds the opening of the sealing element on the surface of the sealing element.

As a result of a circumferential attachment of this type, a high sealing effect between sealing element and retaining means can be achieved. Preferably, both retaining means are attached to the sealing element in this way.

It is preferred, in particular if the sealing element comprises an elastic material, to connect the sealing element in a frictional fit to the first and/or second retaining part, for example by clamping.

Basically, an integral or form-fitting connection is also not precluded, for the latter the sealing element preferably having a rigid region in order that the form-fit can be retained. A combination of the different attachment possibilities is of course likewise possible.

A further advantageous development of the invention provides that the first retaining part is rotatable about an axis of rotation relative to the second retaining part, the attachment points of the first and second retaining part on the sealing element being chosen such that there is no plane orientated perpendicular to the axis of rotation, on which plane both an attachment point of the first and an attachment point of the second retaining part are located.

This has the result that there is always a spacing between a first and second attachment point parallel to the axis of rotation. This spacing enables defined compression of the sealing element.

According to the configuration of the sealing element and distribution of the attachment points, it is possible that the sealing element is compressed at a plurality of places.

A further advantageous development of the invention provides that the sealing element is configured in the form of a disc, a ring or a hose.

A certain axial extension of the sealing element is basically advantageous in order that the sealing element, with suitable choice of attachment points, can be compressed as a result of the rotation.

Such an axial extension is however not absolutely necessary to ensure the function of the seal. Also all the attachment points of the first and second retaining parts can in particular be situated in a common plane perpendicular to the axis of rotation of the retaining parts.

A further advantageous development of the invention provides that the sealing element is curved inwards at least in a partial region surrounding the opening and the attachment points of the first retaining part are located in the one and the attachment points of the second retaining part in the other of the regions of the sealing element which are separated from each other by the apex of the curve.

Where the sealing element is compressed during rotation of the retaining parts is specified preferably by the inwardly curved region.

Basically, also a curvature outwards is possible but then requires more rotations to reduce the opening cross-section of the opening of the sealing element. Also multiple curvature, i.e. an undulating profile of the sealing element, is possible.

A further advantageous development of the invention provides that the sealing element has a rotationally symmetrical configuration, and the attachment points of the first retaining part and of the second retaining part on the sealing element are situated on respectively a first or second circle which is orientated perpendicular to the axis of symmetry of the sealing element, in the case of frequent use.

As a result of the rotationally symmetrical configuration of the sealing element and the circular arrangement of the attachment points about the axis of symmetry of the sealing element, as uniform a mechanical loading of the sealing element as possible is achieved during rotation of the retaining parts. This is crucial in particular for the durability of the sealing element.

A further advantageous development of the invention provides that the radius of the first circle is identical to the second circle.

This symmetry is advantageous for reducing the loading of the sealing element during rotation of the retaining parts. However, basically also different radii are possible, i.e. an asymmetrical arrangement of the attachment points.

A further advantageous development of the invention provides that the first retaining part is rotatable relative to the second retaining part about precisely one axis of rotation.

Preferably, this axis of rotation is the axis of symmetry of the sealing element.

A further advantageous development of the invention provides that the retaining means has a locking means, with which the first retaining part and second retaining part can be locked in a position rotated relative to each other.

This is advantageous in particular when the sealing element is elastic, i.e. a restoring force acts on the mutually rotated retaining parts due to the deformed sealing element.

A locking means of this type can be produced constructionally for example via a locking connection in which for example projections of the first retaining part engage in respectively a groove of the other retaining part in a form-fit. The grooves can be chamfered on one side in order to enable simple further rotation of the retaining parts in one direction of rotation. The two retaining parts can be returned to their basic position in that firstly the retaining part with the projections is pulled away from the other retaining part, so that the projections exit the recesses, and is then rotated back.

A further advantageous development of the invention provides that the first and/or the second retaining part has or have an opening which is or are disposed flush with the opening of the sealing element.

A further advantageous development of the invention provides that the opening cross-sections of the openings of the first and second retaining part, in a basic state of the retaining parts, completely overlap the opening cross-section of the sealing element in alignment.

Preferably, both retaining parts have an opening of this type. As a result of such openings there is possibly less danger that objects which are intended to be led through the opening of the sealing element strike directly against the sealing element when being led through and damage the sealing element.

Furthermore, the invention produces a vessel having a cover and a container in which the cover is formed by a rotary seal according to one or more embodiments, a retaining part of the rotary seal being attached to the container in a fluid-impermeable manner, and the vessel having a connection for a pump, which is led through towards the inner volume of the container, in order to pump the inner volume of the container.

In particular, a part of a retaining part or the entire retaining part can be part of the vessel, for example have an integral configuration with the vessel.

A vessel of this type is suitable in particular for rinsing hollow, tubular elements, in particular medical hollow instruments or hollow shaft instruments.

In particular, the rotary seal according to the invention is of course suitable also for other purposes.

As a further application, the rotary seal according to the invention can act for example as leadthrough between two chambers, for example as a leadthrough for cables. A retaining part can be configured in this case as part of a wall. Furthermore, the rotary seal according to the invention can be used for vibration-damped pipe and line leadthroughs. A further application is the configuration of the rotary seal as a quick closure for drinking bottles or medical supply flasks. A further application of the rotary seal is the use of the rotary seal for cable and pipe lead-ins, which are to be actuated rapidly, including for plug connection parts for military ABC containers or mobile building site devices.

### BRIEF DESCRIPTION OF THE DRAWINGS

The invention is now explained in more detail with reference to embodiments which are represented by several Figures. There are thereby shown:

FIG. 1 a vessel having a rotary seal according to the invention,

FIG. 2 the vessel in an exploded representation,

FIG. 3a a section of the sealing element used in the rotary seal,

FIG. 3b a perspective representation of this sealing element,

FIG. 4 a schematic diagram of the sealing element having a tubular element introduced into the opening of the sealing element,

FIG. 5 a second embodiment of a sealing element according to the invention,

FIG. 6a and

FIG. 6b a third embodiment of a sealing element according to the invention, and

FIG. 7 a fourth embodiment of a sealing element according to the invention.

### DETAILED DESCRIPTION OF THE INVENTION

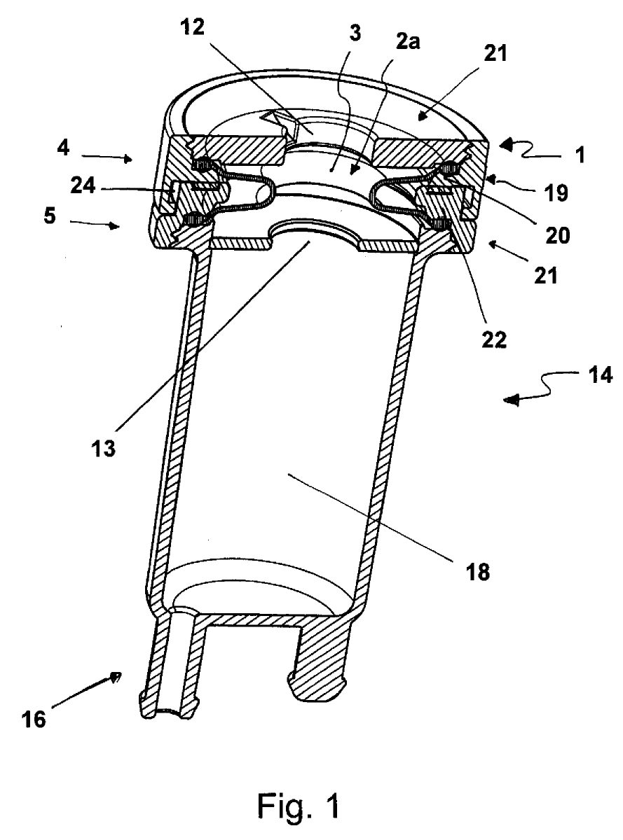

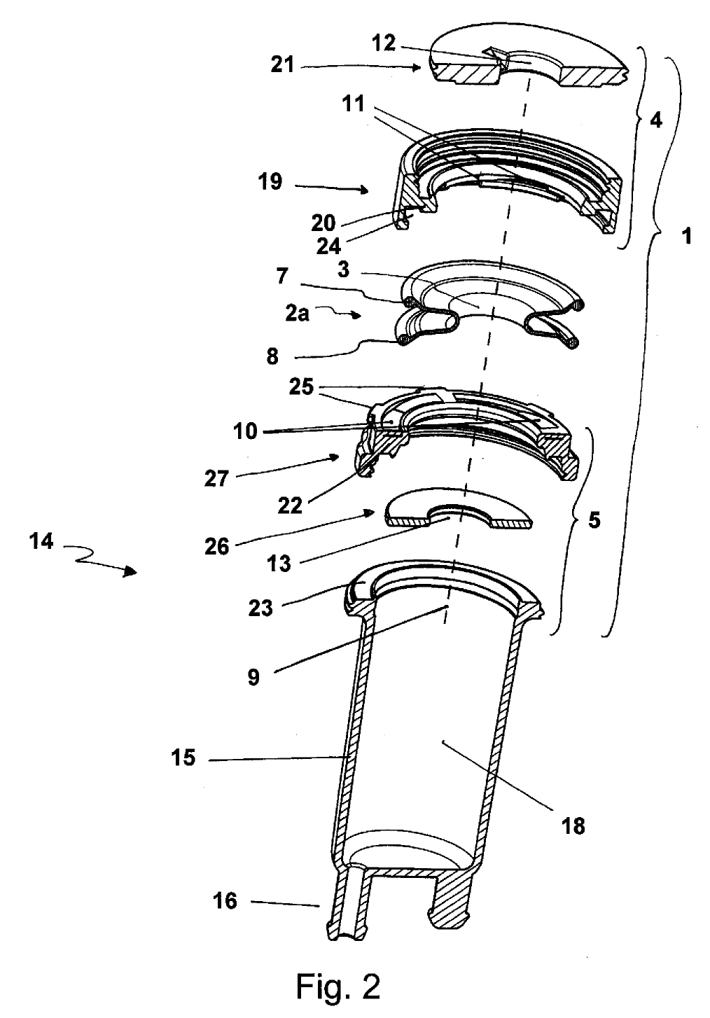

FIG. 1 shows a vessel 14 having a cover and a container 15 in which the cover is formed by an embodiment of a rotary seal 1 according to the invention. For the sake of clarity, the front half of the vessel has been omitted. The omitted other half is produced essentially by the mirror-image of the shown half. FIG. 2 shows the same vessel 14 in an exploded representation.

The rotary seal 1 contains a sealing element 2a and a retaining means. The sealing element 2a is configured as a planar structure with an opening 3 which can be changed in its opening cross-section. The retaining means has a first retaining part 4 and a second retaining part 5 which are rotatable relative to each other. The first retaining part 4 and second retaining part 5 are connected securely to the sealing element 2a respectively at attachment points 7, 8.

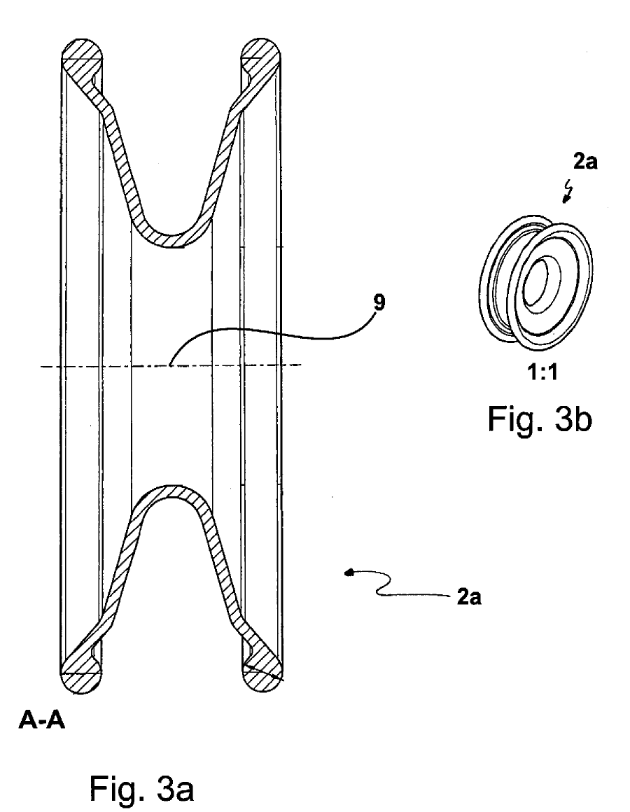

In this embodiment, the sealing element 2a is configured as a ring with a rotationally symmetrical form (see also FIGS. 3a and 3b). Apart from the opening 3 which is located in the centre of the sealing element 2a, the surface of the sealing element 2a is continuous.

The sealing element 2a is curved inwards surrounding the opening 3. With respect to the plane in which the apex of the curve is situated, which is therefore perpendicular to the axis of symmetry 9, the sealing element 2a has a mirror-image symmetrical configuration.

At its respectively upper and lower situated outer edges, the annular sealing element 2a is configured with a circular bead 7, 8 in order to reinforce and to facilitate the attachment.

In this embodiment, the sealing element 2a is configured in one piece from an injection mouldable, highly elastic material. Here, a special addition-cross-linked silicon rubber type with a Shore A hardness of 20, a breaking elongation of 800% and a resistance to tear propagation of>20 N/mm was used. This material is characterised in that it is resistant relative to chemical disinfectants, contains no plasticisers and cannot be damaged by ultrasound, in particular can cope with high mechanical loads.

The first retaining part 4 has an annular receiving shape 19 configured as a rotary ring which, on its inner face, has an annular web 20. On this web 20 the one annular bead 7 of the sealing element 2a is situated, surrounding the opening 3 without interruption. With a perforated clamping disc 21 which is screwed into the receiving shape 19 by means of a thread, the bead 7 of the sealing element 2a is pressed against the web 20 of the receiving element 19 along a continuous, uninterrupted line.

In a similar manner, the sealing element 2a is connected to the second retaining part 5. The second retaining part 5 has an annular receiving shape 27 which is configured as a retaining ring and has a web 22 located on the inner surface. On this web 22, the second bead 8 of the sealing element 2a is situated surrounding the opening 3 without interruption. The cylindrical container 15 which is open on one side has a flange-like configuration with an annular support surface 23 in the region of its opening. Via a thread, the retaining ring 27 can be screwed onto the flange-like region of the container 15. In the screwed-on state, the second bead 8 of the sealing element 2a is clamped between the web 22 of the retaining ring 27 and the flange-like edge region 23 of the container 15 (the flange-like region 23 of the container 15 is hence a part of the retaining part 5).

The first retaining part 4 and second retaining part 5 are hence attached to the sealing element 2a, without interruption, along a continuous line, which surrounds the opening 3 of the sealing element 2a on the surface of the sealing element 2a, namely along the bead 7, 8. Because of the elasticity of the sealing element 2a and as a result of the fact that the clamping effect on the sealing element 2a can be reinforced further by further screwing-down of the clamping disc 21 of the first retaining part 4 and screwing on of the retaining ring 27 onto the flange-like edge region 23 of the container 15, a very high sealing effect can be produced in the region of the bead 7, 8 of the sealing element 2a, which prevents a fluid, in particular a liquid or a gas, or even however a pasty medium, being able to penetrate at these positions.

The first retaining part 4 and second retaining part 5 are rotatable relative to each other precisely about an axis of rotation 9, the axis of rotation 9 corresponding to the axis of symmetry 9 of the sealing element 2a. The support surfaces for the beads 7, 8 of the sealing element 2a of the web of the rotary ring 19 of the first retaining part 4 and of the web 22 of the retaining ring 27 of the second retaining part 5 likewise have a rotationally symmetrical configuration in the mentioned axis. The attachment points 7, 8 of the first retaining part 4 and of the second retaining part 5 on the sealing element 2a are hence situated on respectively a first or second circle which is orientated perpendicular to the axis of symmetry 9 of the sealing element 2a. These circles have an identical diameter in particular in this embodiment.

In order to establish the axis of rotation 9, the rotary ring 19 of the first retaining part 4 has an annular groove 24 which is introduced in the inner surface thereof and into which, on the outer surface of the retaining ring 27 of the second retaining part 5, projections 25 which are disposed in an annular location engage.

Furthermore, the retaining means has a locking means with which the first retaining part 4 and second retaining part 5 can be locked in a position rotated relative to each other.

In this embodiment, the retaining ring 27 of the second retaining part 5 has, on the rear side of the web 22, situated opposite the support surface for the bead 8 of the sealing element 2a, recesses 10 which are scattered and disposed in a circle about the axis of rotation 9. The rotary ring 19 of the first retaining part 4 has scattered projections 11 which are disposed in a circle about the axis of rotation 9 and can engage in the recesses 10 of the retaining ring 27. By means of engagement of the projections 11 of the rotary ring 19 into the recesses 10 of the retaining ring 27, a form-fit is formed which locks the first and second retaining part 4, 5 in their position.

In this embodiment, the recesses 10 of the retaining ring 27 are chamfered on one side so that, during rotation of the retaining parts 4, 5 in one direction, the projections 11 of the rotary ring 19 are raised out of the recesses 10 of the second retaining part 5 because of the inclination. In this way, it is possible to rotate the two retaining parts, 4, 5 easily in one direction, but rotation back in the other direction is blocked. This is advantageous in particular in this embodiment since an elastic sealing element 2a is used which builds up restoring forces during rotation.

The rotation back of the retaining parts 4, 5 can be effected in that the first retaining part 4 is raised slightly so that the projections 11 of the retaining part 4 are lifted out of the recesses 10 of the retaining part 5. The guidance of the projections 25 of the second retaining part 5 in the groove 24 of the first retaining part 4 is configured with sufficient clearance for this purpose.

The first retaining part 4 and second retaining part 5 both have an opening 12, 13 which are disposed flush with the opening 3 of the sealing element 2a. The opening in the first retaining part 4 is located in the clamping disc 21, the second opening 13 in the second retaining part 5 is formed by the opening of a perforated disc 26 which is clamped just below the edge in the opening region of the container 15 in a groove located in the inner wall of the container 15. Both openings 12, 13 are cylindrical and have the axis of rotation 9 of the retaining parts 4, 5 or the axis of symmetry 9 of the sealing element 2a as axis of symmetry. The diameter of the openings 12, 13 is thereby smaller than the minimum diameter of the opening 3 of the sealing element 2a which is formed by the apex of the curve, the sealing element 2a being located in a non-rotated, non-deformed state, i.e. in the basic state.

The rotary seal 1 is attached in a fluid-impermeable manner on the one open end of the cylindrical container 15. The other end of the container is sealed by a base. In the region of the base of the container 15, a leadthrough 16 which is configured in the form of a connection piece towards the inner volume 18 of the container 15 is provided, to which leadthrough a pump can be connected for example via a hose.

Container 15, disc-shaped element 21 and receiving shape 19 of the first retaining part, and also receiving shape 21 and disc-shaped insert 26 of the second retaining part are produced respectively in one piece from injection mouldable plastic material. A material which is transparent in water was used specially for the container 15.

The sealing element 2a is retained by the retaining parts merely at the beads 7, 8. The remaining region is free and hence deformable. By rotation of the first and second retaining part 4, 5, the sealing element 2a retained by the retaining parts 4, 5 is deformed in such a manner that the opening 3 of the sealing element 2a is reduced in its opening cross-section. Complete closure of the opening 3 is even possible with the embodiment shown here.

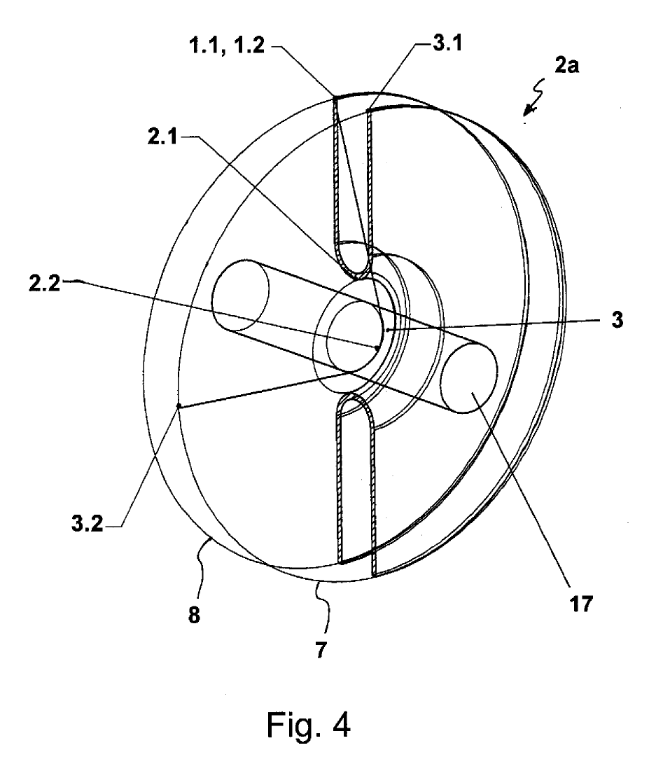

The reason for such a deformation of the sealing element 2a being produced is intended to be explained in more detail with reference to FIG. 4.

FIG. 4 shows the sealing element 2a in a simplified representation. Furthermore, a tubular element 17 is introduced into the opening 3 of the sealing element 2a.

The one outer edge 7, retained by the first retaining part 4, is now rotated relative to the stationary outer edge 8, attached to the second retaining part 5, by rotation of the two retaining parts relative to each other. The displacement of specific selected points on the sealing element 2a from a basic state 1 into a rotated state 2 is intended to be observed.

Point 1.1 on the non-moved outer edge 8 of the sealing element 2a does not change its position during the rotation since it is retained by the non-moved second retaining part 5. In the rotated state 2, the position 1.2 of this point hence corresponds to the previous position 1.1. The point 3.1 which is located on the outer edge 7 of the sealing element 2a is transferred into a position 3.2 by rotation of the first retaining part 5.

Point 2.1 which is located in the basic state of the sealing element 2a on the half of the shortest connecting line between the points 1.1 and 3.1 which extends along on the surface of the sealing element 2a, i.e. on the apex of the curve of the sealing element 2a, is guided around the tubular element 17 by means of the circular displacement of point 3.1, approaches the latter helically and abuts finally on the surface thereof, as the state 2.2 illustrated in FIG. 4 shows.

This principle applies to each point 1.1′; and 3.1′; which are located on the outer edge 7 or 8 which is retained by the first retaining part 4 or second retaining part 5. Since only the outer edges 7, 8 are retained by the retaining parts, this leads to the fact that the sealing element 2a is compressed in the centre around the tubular element 17, in particular closes the still open region in the basic state of the sealing element 2a between the tubular element 17 and non-deformed sealing element 2a. As a result of the force of the rotation, it can be determined how tightly the sealing element abuts against the tubular element 17, as a result of which the sealing effect can be correspondingly improved. This is assisted by the elastic element of the sealing element 2a.

Without tubular element 17, with sufficient rotation the sealing element 2a would wind up in its centre. In this way, complete closure of the opening 3 is possible.

The above description represents the principle according to which the opening 3 is closed by means of rotation of the outer edges 7, 8 of the ceiling element 2a in a very simplified manner. In reality, the sealing element 2a is not drawn together uniformly in the centre thereof but forms folds. Nonetheless, the opening cross-section of the opening 3 is reduced, in particular a very good sealing effect between sealing element 2a and enclosed element 17 is possible. By means of the dimensions of the sealing element, indicated in FIG. 3a, and the described material, it was possible in particular to produce seals for tubular objects with a diameter of 1 to 10 mm which withstood the pressure differences of 0.8 bar without difficulty.

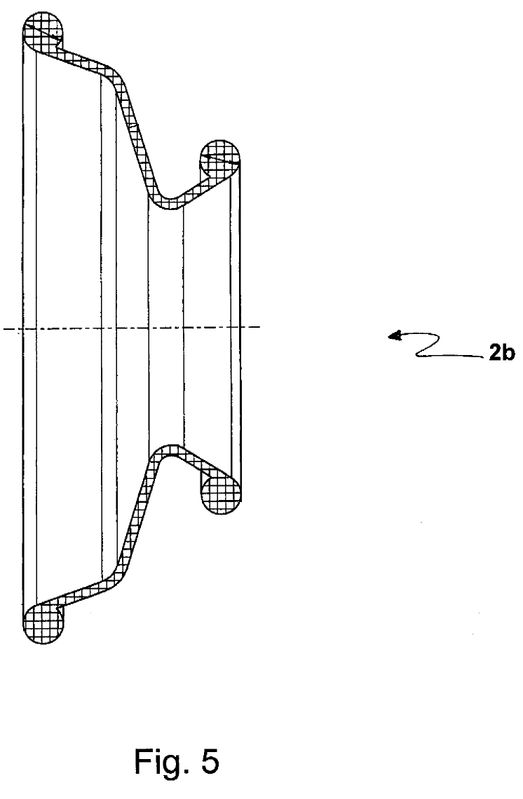

FIG. 5a shows an alternative second embodiment of a sealing element which can be used within the scope of a rotary seal according to the invention. Deviating from the first embodiment of the sealing element 2a, the two bead-shaped outer edges of the annular sealing element 2b which is curved inwards do not have the same radius but one of the outer edges is configured with a significantly smaller radius. The sealing element 2b is therefore asymmetrical.

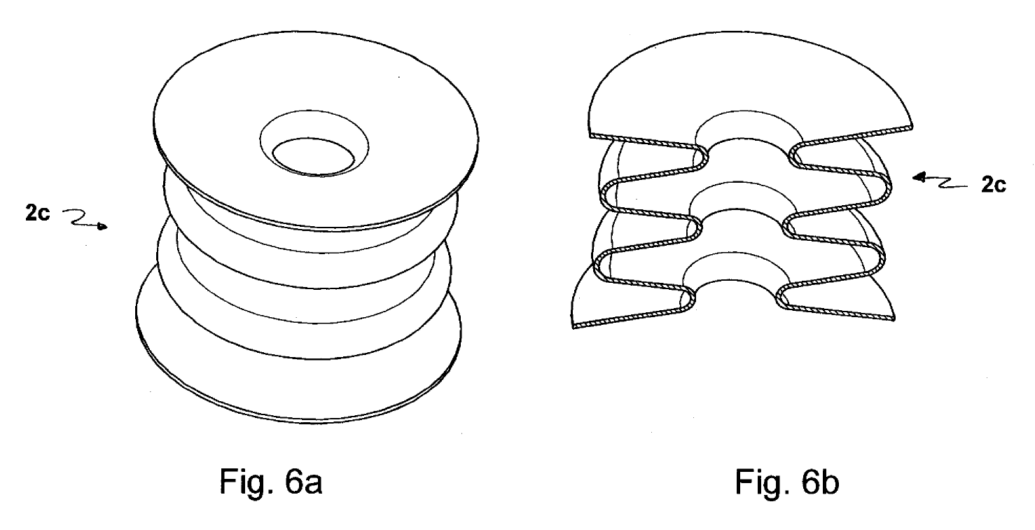

FIGS. 6a and 6b show a third embodiment of a sealing element 2c which can be used as part of a rotary seal according to the invention. According to this third embodiment, the sealing element 2c is configured as rotationally symmetrical bellows with a plurality of undulations.

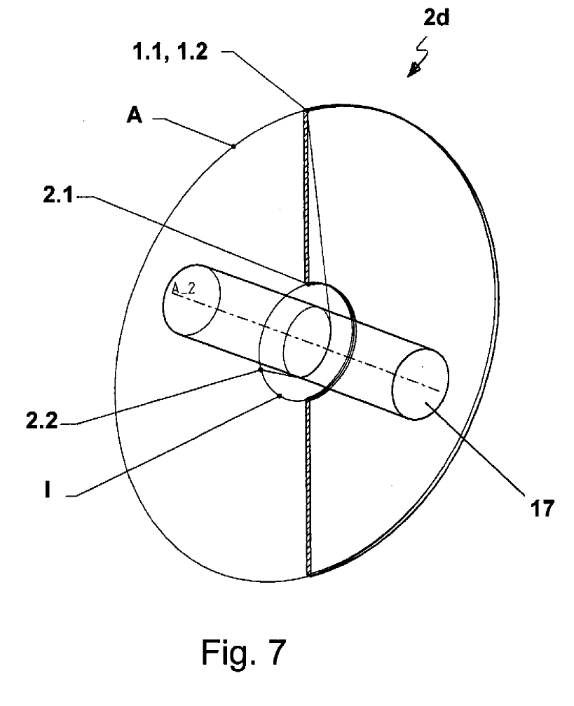

FIG. 7 shows a fourth embodiment of a sealing element 2d which can be used as part of a rotary seal 1 according to the invention.

The sealing element 2d is configured as a perforated disc. By rotating the outer edge A relative to the inner edge 1, the sealing element 2d is deformed in such a manner that the opening of the sealing element 2d is reduced in its opening cross-section. In FIG. 7, this is represented in a simplified manner analogously to FIG. 4 by the position of different points in the basic state and in a rotated state of the sealing element 2d. In reality, the sealing element 2d is folded over on one side of the disc and is compressed there, i.e. the original planar form is abandoned.

As an alternative to the above-described embodiments of the sealing element, it is basically likewise possible to use non-elastic materials. Also a combination of rigid and elastic materials is basically possible, in particular if dimensional stability is desired in a partial region of the sealing element.

The vessel according to the described embodiment is suitable in particular for rinsing hollow, tubular elements 17, in particular medical hollow instruments.

Various types of medical tubular shaft or hollow instruments with different diameters can be introduced by one end through the openings 12, 3 and 13 of the rotary seal into the inner volume 18 of the container 15 and be sealed very well against the outer chamber via rotation of the retaining parts 4, 5 of the rotary device 1. As a result of the fact that the openings 12, 13 of the retaining parts in the non-rotated state of the sealing element 2a are smaller in their opening cross-sections than the opening cross section of the opening 3 of the sealing element 2a, the instrument is prevented from damaging the sealing element 2a during introduction of the instrument.

The instrument can be placed together with the vessel 14 in a rinsing liquid. By pumping the inner volume 18 via the connection piece 16, rinsing liquid is suctioned through the hollow instrument into the inner volume 18 and then towards the pump.

As a result of the good sealing effect of the rotary seal, it can be ensured that the rinsing liquid is actually suctioned through the hollow instrument and hence a cleaning effect occurs. In addition, it is possible to supply ultrasound to the cleaning liquid, the vessel 14, with the proviso that the inner volume 18 is filled with liquid, being able to conduct the ultrasound also to the region of the hollow instrument situated in the vessel 14.

1. A rotary seal, comprising a sealing element and a retaining means, the sealing element being configured as a planar structure with an opening which can be changed in its opening cross-section and the retaining means having a first retaining part and a second retaining part which can be rotated relative to each other, and first retaining part and second retaining part respectively being connected securely to the sealing element at least at one attachment point , the attachment points being chosen such that the sealing element can be deformed by rotation of the first and second retaining part such that the opening of the sealing element is reduced in its opening cross-section.

2. A seal according to claim 1, characterised in that wherein at least the first and/or second retaining part is attached to the sealing element, without interruption, along a continuous line (7, 8) which surrounds the opening (3) of the sealing element (2a) on the surface of the sealing element (2a).

3. A seal according to claim 1 wherein the first retaining part is rotatable about an axis of rotation relative to the second retaining part, the attachment points of the first and second retaining part on the sealing element being chosen such that there is no plane orientated perpendicularly to the axis of rotation, on which plane both an attachment point of the first and an attachment point of the second retaining part are located.

4. A seal according to claim 1 wherein the sealing element is configured in the form of a disc, a ring or a hose.

5. A seal according to claim 1 wherein the sealing element is curved inwards at least in a partial region surrounding the opening and the attachment points of the first retaining part are located in the one and the attachment points of the second retaining part in the other of the regions of the sealing element which are separated from each other by the apex of the curve.

6. A seal according to claim 1 wherein the sealing element has a rotationally symmetrical configuration, and the attachment points of the first retaining part and of the second retaining part on the sealing element are situated on respectively a first or second circle which is orientated perpendicular to the axis of symmetry of the sealing element.

7. A seal according to claim 7 wherein, a radius of the first circle is identical to that of the second circle.

8. A seal according to claim 1 wherein the first retaining part is rotatable relative to the second retaining part about precisely one axis of rotation.

9. A seal according to claim 1 wherein the retaining means has a locking means, with which the first retaining part and second retaining part can be locked in a position rotated relative to each other.

10. A seal according to claim 1 wherein the first and/or the second retaining part has or have an opening which is or are disposed flush with the opening of the sealing element.

11. A seal according to claim 10, wherein the opening cross-sections of the openings of the first and second retaining part-, in a basic state of the sealing element, completely overlap the opening cross-section of the sealing element in alignments.

12. A seal according to claim 1 wherein the sealing element comprises in at least one region an elastic material.

13. A seal according to claim 12, wherein the sealing element comprises at least in one region silicon rubber, thermoplastic elastomers, natural rubber and/or polymer latex.

14. A seal according to claim 12 wherein the elastic region of the sealing element has a breaking elongation of at least 300%.

15. A vessel comprising a cover and a container in which the cover is formed by a rotary seal according to claim 1, a retaining part of the rotary seal being attached to the container in a fluid-impermeable manner, and the vessel having a connection for a pump, which is led through towards an inner volume of the container in order to pump the inner volume of the container.

16. A vessel according to claim 15 operable to, rinse hollow, tubular elements.

17. A seal according to claim 12 wherein the sealing element is formed completely of an elastic material.

18. A seal according to claim 12 wherein the elastic region of the sealing element has a breaking elongation of at least 600%.

19. A seal according to claim 12 wherein the elastic region of the sealing element has a breaking elongation of at least 800%.
